(19) United States
(12) Patent Application Publication
(10) Pub. No.: US 2026/0118841 A1
(43) Pub. Date: Apr. 30, 2026

(54) SELF-ADAPTIVE METHOD FOR THE ORIENTATION OF COMPONENTS

(71) Applicant: AISAPACK HOLDING SA, Vouvry (CH)

(72) Inventors: Fouad THELJANI, Monthey (CH); Stéphane EMERY, Lens (CH)

(21) Appl. No.: 19/118,515

(22) PCT Filed: Oct. 16, 2023
(86) PCT No.: PCT/IB2023/060403

§ 371 Date: Apr. 4, 2025

(30) Foreign Application Priority Data
Oct. 17, 2022 (EP) 22201943.2

(51) Int. Cl. G05B 13/04; G05B 13/02

(52) U.S. Cl. CPC G05B 13/042; G05B 13/0265

(57) ABSTRACT

Self-adaptive method for the orientation of components in real time, such as packaging components, in which an adjusted command is applied to at least one actuator so as to orient at least one component, the oriented component then undergoes a transformation, and after the transformation its orientation is measured so as to obtain the measured characteristics of its orientation, the command being adjusted gradually on the basis of the orientation characteristics of the components already measured.

### CORRESPONDING APPLICATION

The present PCT application claims priority to earlier European Patent application N° EP22201943.2 filed on Oct. 17, 2022 in the name of AISAPACK HOLDING SA, the content of the earlier application being incorporated by reference in its entirety in the present PCT application.

### FIELD OF THE INVENTION

The invention relates to the field of methods for producing packaging, and more specifically flexible packaging produced by assembling oriented components. The invention may be used for example for the production of packaging tubes intended in particular, but not exclusively, for packaging liquid or viscous products, semi-liquid products or products in powder form.

Naturally, the present invention does not only apply to the production of packaging tubes, but may be applicable to other fields in which the production of an item results from the assembly of oriented components.

### PRIOR ART

Publication WO2016055924 (incorporated by reference in its entirety in the present application) proposes a method for orienting a cap with respect to a printed tube body in which the angular correction is determined by taking into account a signal modelled during a learning phase. The method described in WO2016055924 leads to a significant reduction in the time required for settings as well as making it possible to remove from the production batch any assemblies that are not oriented correctly, thanks to the real time measurement of the difference between the desired orientation and the measured orientation. This method has a number of advantages but does however require the intervention of an operator to adjust the machine commands when a fall in quality is observed. Such a fall in quality may be linked to changes in the environment in which the production machine is located, to changes in the components used on the machine (geometry, materials), or to deterioration associated with the machine (heating up, wear).

Another problem which is not solved by WO2016055924 concerns multi-track assembly methods for assembling oriented components in which several assembly tracks are processed sequentially and/or simultaneously, and each track has a different behaviour affecting the final orientation between the components. This is the case in particular with rotary platforms comprising several tracks, such as indexing turntables comprising several mandrels, each mandrel corresponding to a track; see, for example, publications WO2007141711, WO2010054804 and WO2015001453, all incorporated by reference in their entirety in the present application. With this type of device, there are deviations (mean and standard deviation) between the desired orientation and the measured orientation, which are different for each track. Optimizing the settings of the orientation device for all of the tracks as a whole offers the best overall compromise but this approach may be insufficient in cases where the orientation must be very precise.

The present invention aims to overcome the abovementioned drawbacks by virtue of a self-adaptive production method which adjusts the orientation commands and/or parameters of the machine in real time on the basis of measured characteristics of the oriented items. Specifically, this method allows self-adjustment of the orientation of each track individually, so as to ensure optimal orientation precision regardless of changes in the production environment; regardless of variations between the components; regardless of differences in behaviour between the tracks; regardless of differences in behaviour between the orientation actuators; and regardless of changes arising from wear and/or heating up of the machine.

### GENERAL DISCLOSURE OF THE INVENTION

An aim of the invention is to improve methods and devices for producing packaging by assembly of oriented components, especially packaging tubes intended in particular, but not exclusively, for packaging liquid or viscous products, semi-liquid products or solid products (for example in powder form).

Another aim is to propose a self-adaptive orientation method and station/device which adjust their commands in real time to obtain assembled components with very precise and uniform orientation regardless of changes in the production environment, and/or regardless of variations in the properties of the assembled components, and/or regardless of changes linked to the production equipment.

Another aim is to propose an orientation method and station that make it possible to reduce the differences between items in the same production batch.

Another aim is to propose an orientation method and station that can be implemented simply and efficiently.

Another aim is to propose an orientation method and station that can be implemented simply and make it possible to improve the precision of transformation operations; said transformation operations may be, for example, transfer or placing operations; or assembly, welding or bonding operations of parts; or moulding or overmoulding operations; or capping operations involving snap-fitting or screwing of parts together; or filling operations; or sealing operations, or packing operations such as putting oval tubes in boxes.

Another aim of the invention is to improve the precision of orientation used in methods referred to as multi-track, such as rotary turntables or parallel linear systems. The invention makes it possible, with a minimum number of actuators and measuring devices, to improve the effective orientation precision of multi-track devices.

Another aim is to propose orientation methods and modular systems which can be implemented on existing machines.

Other aims and solutions arising from the present invention will be described in the text below and in the embodiments of the present invention.

The invention relates to a method for the orientation of components at high production rates, and in particular a single-track or multi-track orientation method implemented on a rotary device.

The invention concerns in particular a method for the orientation of components with self-adaptive commands in real time, on the basis of the measurement of one or more characteristics of the orientation during production, without shutting down the machine. The measured characteristic of the orientation is primarily the deviation between a desired value and a measured value of the orientation, but other characteristics may be determined such as, for example, the average value of the orientation per track; or the standard deviation of the orientation per track, in the case of a multi-track configuration. The measurement of these characteristics makes it possible to detect and to anticipate any wear or damage to the multi-track rotary device so that preventive maintenance can be carried out. According to the invention, the characteristics of the oriented component are compared in real time with the characteristics of a reference.

The invention concerns in particular a method for the orientation of a component on a tubular body used for packaging; said component being for example a head of a tube or a cap, or a neck of a bottle, or a base of a bottle. According to the invention, the multi-track orientation method may be carried out at a high production rate and includes an adjustment of the orientation command, self-adaptive and optimized for each track of the machine.

According to embodiments of the invention, the method manages a plurality of actuators, the actuator being, in the method, the orientation device or station that receives the orientation command and places the component in the oriented position. Thus, according to the invention the method may manage a plurality of actuators that respectively supply a plurality of tracks. This is the case in particular of turntables comprising n times k mandrels in parallel and k actuators. For example, for a turntable comprising six times two mandrels in parallel and two actuators, the total number of tracks is twelve and each actuator is assigned six tracks, respectively. According to another example illustrated in the publication WO2007141711, the turntable includes eight times six mandrels, i.e. forty eight tracks in total.

The invention aims to orient, with great precision and with little disparity, components in an assembly process performed at a high production rate.

In embodiments, the invention concerns a self-adaptive method for the orientation of components in real time, such as packaging components, in which an adjusted command is applied to at least one actuator so as to orient at least one of said components, wherein the oriented component then undergoes a transformation, and after the transformation its orientation is measured so as to obtain measured characteristics of its orientation after transformation, wherein the command is adjusted gradually on the basis of the orientation characteristics of the components which have been measured after transformation.

In embodiments, the adjusted command is obtained by means of a self-adaptive theoretical model which self-adjusts in order to find its optimal parameters.

In embodiments, the optimal parameters of the model are obtained by minimizing the deviation between the measured characteristics and theoretical characteristics calculated by the model.

In embodiments, a plurality of components is oriented, each one on a corresponding track.

In embodiments, the measurement of the orientation is optical. Other equivalent means may be used for this measurement.

In embodiments, the transformation operation is for example assembling, and/or welding and/or bonding and/or moulding and/or overmoulding operations; and/or capping operations involving snap-fitting of a part; and/or screwing of parts and/or packing operations such as putting oval tubes in boxes. It can also be a combination of several of them.

In embodiments, a module for self-adaptive correction of the orientation comprises a plurality of self-adjustable theoretical models of the orientation station.

In embodiments, the module for self-adaptive correction of the orientation includes a self-adjustable theoretical model per track of the orientation station and/or per actuator of the orientation station.

In embodiments, the self-adjustable theoretical model is a mathematical function and/or a polynomial function and/or a fractional function, and/or a non-linear function (logarithmic, exponential), and/or a black box mathematical function such as a neural network.

In embodiments, the parameters of the model are adjusted by an incremental algorithm, RLS (Recursive Least Squares) and/or by quadratic optimization (quadratic programming) and/or by gradient descent optimization.

In embodiments, the command is mono-variable, for example it comprises angular position, and/or the command is multi-variable, for example, it comprises angular position, and/or speed of rotation and/or torque.

In embodiments, an end piece is overmoulded on a tubular body.

In embodiments, a tube is capped by mounting a cap on the head of a printed tube.

In embodiments, the invention concerns a device for implementing the method described in the present application, said device comprising at least an actuator, a single-track or multi-track transformation device, a device for measuring orientation, and means for processing the measurements, said device further comprising a single-track or multi-track self-adaptive correction module that generates the optimal parameters of the model for each track and the optimal command for each track.

### DETAILED DESCRIPTION OF THE INVENTION

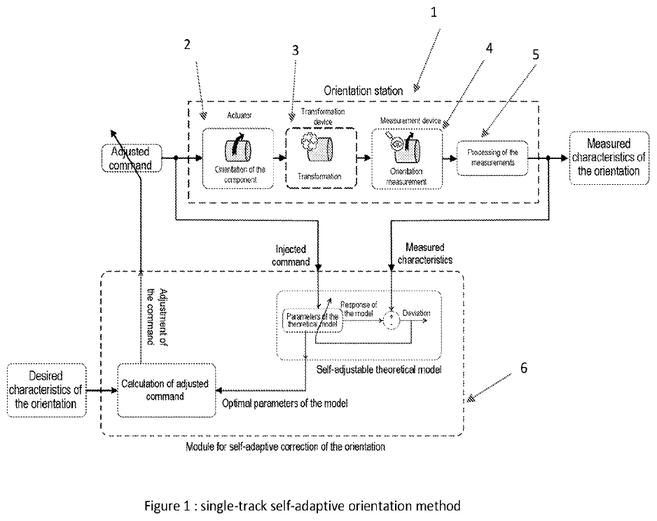

The principle of the invention is illustrated in FIG. 1. The orientation method uses at least an orientation station and a module for self-adaptive correction of the orientation.

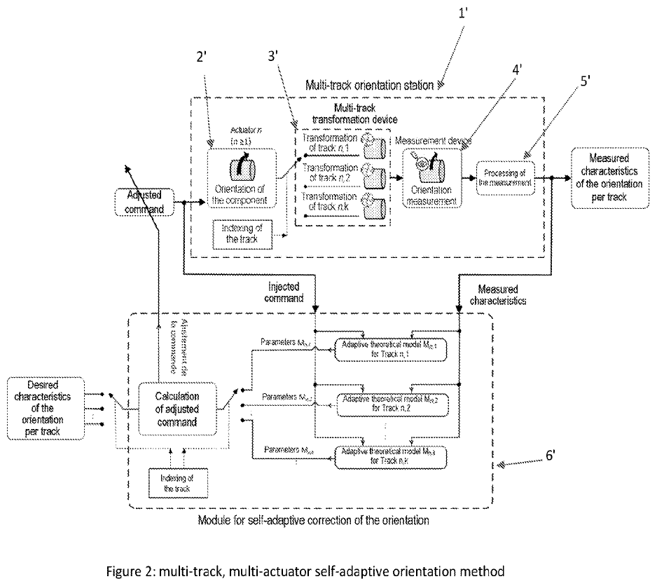

FIG. 2 illustrates an extension of the method illustrated in FIG. 1 to a multi-track (in FIG. 2, three tracks are shown by way of a non-limiting example) and multi-actuator method.

### ORIENTATION STATION

The orientation station 1, 1′ carries out at least an operation of orientation of the component, and an operation of measuring the effective orientation of the oriented component so as to determine its actual orientation. The orientation station 1, 1′ carries out one or more operations referred to as transformation operations after the orientation step and before the step of measuring the actual orientation.

Orientation of the component is performed using actuators 2, 2′ known in the prior art and capable of orienting the component at a high production rate. One example of a robust actuator 2, 2′ which does not require long setting times, thanks to the use of algorithms, is described in publication WO 2016/055924.

The characteristics of the actual orientation of the component after any transformation operations carried out by transformation device 3, 3′ are measured by a measurement device 4, 4′ for measuring orientation, such as an optical camera or an optical sensor, or any other suitable sensor. The measurements resulting from the transformation device 3, 3′ are processed in a processing device 5, 5′ so as to ultimately obtain the measured characteristics of the orientation of the component in question.

The operations referred to as transformation operations may include steps of assembly of a component, steps of positioning the component (positioning on a conveyor belt, positioning in a box, positioning on a mandrel, etc.).

According to embodiments of the invention, the transformation operations are performed on a multi-track indexing turntable 3, 3′ for overmoulding a head of a tube on a printed skirt. The tube head is for example of oval geometry; or for example circular with a hole not positioned on the axis of symmetry. According to some alternative embodiments, the turntable is continuously moving.

According to embodiments of the invention, the transformation operations are performed on a multi-track indexing turntable 3 for snap-fitting a hinged cap on a printed tubular body. According to some alternative embodiments, the turntable 3, 3′ is continuously moving.

According to embodiments of the invention, the transformation operations are performed on a multi-track indexing turntable 3, 3′ for welding a cap of a tube on a printed skirt. According to some alternative embodiments, the turntable 3, 3′ is continuously moving.

According to embodiments of the invention, the transformation operations are performed on a multi-track indexing turntable for welding a base (for example oval) on a printed tubular body. According to alternative embodiments, the turntable is continuously moving.

The turntables mentioned hereabove are for example as illustrated in the prior art publications mentioned herein.

### Module for Self-Adaptive Correction of the Orientation

In parallel with the orientation station, a module 6, 6′ for self-adaptive correction of the orientation adjusts in real time the command for the actuator 2, 2′ used to orient the component.

According to embodiments of the invention, the module 6, 6′ for self-adaptive correction of the orientation uses at least one self-adjustable theoretical model that simulates the behaviour of the orientation station 1.

According to embodiments of the invention, the module 6, 6′ for self-adaptive correction of the orientation also calculates the adjusted command for the actuator 2, 2′ using the optimal parameters of the theoretical model self-adjusted in real time.

### Theoretical Model

According to embodiments of the invention, the module 6, 6′ for self-adaptive correction of the orientation includes one or more self-adjustable theoretical models of the orientation station 1, 1′ (digital twins).

According to embodiments of the invention, the module 6, 6′ for self-adaptive correction of the orientation includes a self-adjustable theoretical model per track of the orientation station 1, 1′.

According to embodiments of the invention, the module 6, 6′ for self-adaptive correction of the orientation includes a self-adjustable theoretical model per actuator of the orientation station 1, 1′.

According to embodiments of the invention, the module 6, 6′ for self-adaptive correction of the orientation includes a self-adjustable theoretical model per track and per actuator of the orientation station 1, 1′.

According to embodiments of the invention, the self-adjustable theoretical model is a mathematical function.

According to embodiments of the invention, the self-adjustable theoretical model is a polynomial function.

According to embodiments of the invention, the self-adjustable theoretical model is a fractional function.

According to embodiments of the invention, the self-adjustable theoretical model is a non-linear function (logarithmic, exponential).

According to embodiments of the invention, the self-adjustable theoretical model is a black box mathematical function such as a neural network.

### Method for Adjusting Parameters of the Model in Real Time

According to embodiments of the invention, the parameters of the model are adjusted in real time by minimizing the deviation between the response (to an identical command) of the method (applied to the actuator 2, 2′) and the response of the model (command injected into the model), see FIGS. 1 and 2.

According to embodiments of the invention, the parameters of the model are adjusted by an incremental algorithm, RLS (Recursive Least Squares).

According to embodiments of the invention, the parameters of the model are adjusted by quadratic optimization (quadratic programming).

According to embodiments of the invention, the parameters of the model are adjusted by gradient descent optimization.

According to the invention, the self-adjusted parameters of the model make it possible to calculate in real time the adjusted command for the actuator 1.

### Adjusted Command for the Actuator

According to the invention, the self-adaptive correction module 6, 6′ adjusts in real time the command for the actuator 2, 2′ using the optimized theoretical model and taking into account desired characteristics of the orientation as shown in FIGS. 1 and 2 (calculation of the adjusted command taking into account desired characteristics of the orientation and optimal parameters of the model).

According to embodiments of the invention, the command is mono-variable. For example, the command corresponds to the angular position.

According to embodiments of the invention, the command is multi-variable. for example, the command comprises the angular position, the speed of rotation and the torque. Other variables are of course possible within the frame of the present invention.

### EXAMPLES OF METHODS ACCORDING TO THE INVENTION

### Example 1: Overmoulding Device

In a method for production of a packaging tube by overmoulding of an end piece on a printed tubular body, the tubular body is oriented before being transferred onto the overmoulding turntable. The method employs two actuators 2, 2′ in parallel which orient and distribute the tube bodies on a turntable 3, 3′ comprising six pairs of mandrels. The transformation operations (transfer, overmoulding of the end pieces) are performed on the turntable 3, 3′. Two measuring devices 4, 4′ installed on the turntable 3, 3′ measure the orientation between the end piece and the tubular body after the transformation operation (in this example, the overmoulding).

### Parameters of the Method of Example 1

twelve tracks (six pairs, in other words twelve mandrels)
two actuators 2, 2′ with each actuator assigned to six tracks
twelve theoretical models.

The invention makes it possible to orient the components optimally for each of the twelve tracks and individually (each track has its own theoretical model).

The invention makes it possible to analyse in real time the performance of each of the twelve tracks, of each of the two actuators, and to optimize, anticipate or correct any deterioration in the operation of the device.

### Example 2: Capping Device

In the method for capping a tube by snap-fitting the cap on the head of a printed tube, the cap is oriented before being snap-fitted on the tube, for example to ensure alignment between the printed face and the opening of the cap. The method employs one actuator 2, 2′ which orients and snap-fits the caps on tubes loaded on mandrels arranged on a turntable 3, 3′. Said rotary turntable 3, 3′ includes seven mandrels on which the operations are performed in succession.

The effective orientation between the cap and the tube is carried out after said operations.

### Parameters of the Method of Example 2

seven tracks (seven individual mandrels)
one actuator 2, 2′
seven theoretical models.

According to a variant of example 2, the capping method includes two actuators 2, 2′ in parallel which orient and snap-fit the caps on a turntable 3, 3′ comprising seven pairs of mandrels.

### Parameters of the Variant of the Method of Example 2

fourteen tracks (seven pairs of mandrels, in other words fourteen mandrels)
two actuators 2, 2′ with each actuator assigned to seven tracks
fourteen theoretical models.

### Advantage of the Invention

The invention makes it possible to achieve optimized precise orientation per individual track (each track has its own theoretical model) and a minimum orientation disparity per track; this is far superior to optimized general settings for all of the tracks as a whole.

The invention makes it possible to reduce the time required for settings, by virtue of the integrated self-adjustment function.

The invention makes it possible to compensate for deterioration linked to the machine, the environment and the components.

As there is an ongoing control throughout production, the command for the orientation station 1, 1′ is adjusted automatically and in real time and independently for each track so that the effective characteristics of the orientation on each track are optimal relative to the characteristics of the desired orientation.

When a deterioration of other characteristics such as the standard deviation (dispersion of the orientation measurements) is measured, the invention makes it possible to rapidly diagnose and locate the deficient component or mechanisms and to take preventive action before a malfunction occurs.

The principle of the invention is highly advantageous economically as it prevents rejects and limits human intervention by virtue of self-adjustment of the machine in real time, as soon as a deterioration is detected and before a failure occurs.

The embodiments described in the present application are illustrative examples and must not be considered to be limiting. Other embodiments may use means equivalent to those described, for example. The various embodiments described above may also be combined with one another depending on the circumstances, or means used in one embodiment may be used in another embodiment.

Exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with one exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with several non-limiting embodiments, the scope of the present invention is not so limited. Moreover, while this invention has been described in conjunction with a number of embodiments, it is evident that many alternatives, modifications and variations would be or are apparent to those of ordinary skill in the applicable arts. Accordingly, it is intended to embrace and cover all such alternatives, modifications, equivalents and variations that are within the spirit and scope of this invention.

1. Self-adaptive method for the orientation of components in real time, such as packaging components, in which an adjusted command is applied to at least one actuator so as to orient at least one of said components, wherein the oriented component then undergoes a transformation, and after the transformation its orientation is measured so as to obtain measured characteristics of its orientation after transformation,
in which the command is adjusted gradually on the basis of the orientation characteristics of the components which have been measured after transformation.

2. Method according to claim 1, in which the adjusted command is obtained by means of a self-adaptive theoretical model which self-adjusts in order to find its optimal parameters.

3. Method according to claim 1 in which the optimal parameters of the model are obtained by minimizing the deviation between the measured characteristics and theoretical characteristics calculated by the model.

4. Method according to claim 1, in which a plurality of components is oriented, each one on a corresponding track.

5. Method according to claim 1, in which the measurement of the orientation is optical.

6. Method according to claim 1, in which the transformation operations is assembly, or welding or bonding operations; or moulding or overmoulding operations; or capping operations involving snap-fitting or screwing; or packing operations such as putting oval tubes in boxes.

7. Method according to claim 1, in which the module (6,6′) for self-adaptive correction of the orientation comprises a plurality of self-adjustable theoretical models of the orientation station (1,1′).

8. Method according to claim 1, in which the module (6,6′) for self-adaptive correction of the orientation includes a self-adjustable theoretical model per track of the orientation station and/or per actuator of the orientation station (1,1′).

9. Method according to claim 1, in which the self-adjustable theoretical model is a mathematical function and/or a polynomial function and/or a fractional function, and/or a non-linear function (logarithmic, exponential), and/or a black box mathematical function such as a neural network.

10. Method according to claim 1, in which the parameters of the model are adjusted by an incremental algorithm, RLS (Recursive Least Squares) and/or by quadratic optimization (quadratic programming) and/or by gradient descent optimization.

11. Method according to claim 1, in which the command is mono-variable, for example the angular position, and/or the command is multi-variable, for example, it comprises the angular position, and/or the speed of rotation and/or the torque.

12. Method according to claim 1, in which an end piece is overmoulded on a tubular body.

13. Method according to claim 1, in which a tube is capped by mounting a cap on the head of a printed tube.

14. Device for implementing the method according to claim 1, said device comprising at least an actuator (2, 2′), a single-track or multi-track transformation device (3, 3′), a device for measuring orientation (4, 4′), and means (5, 5′) for processing the measurements, said device further comprising a single-track or multi-track self-adaptive correction module (6, 6′) that generates the optimal parameters of the model for each track and the optimal command for each track.
